(19) United States
(12) Patent Application Publication
(10) Pub. No.: US 2007/0086521 A1
(43) Pub. Date: Apr. 19, 2007

(54) Efficient decoded picture buffer management for scalable video coding

(75) Inventors: Ye-Kui Wang, Tampere (FI); Miska M. Hannuksela, Tampere (FI); Stephan Wenger, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/546,622

(22) Filed: Oct. 11, 2006

Related U.S. Application Data
(60) Provisional application No. 60/725,865, filed on Oct. 11, 2005.

(51) Int. Cl. H04B 1/66; H04N 7/12

(52) U.S. Cl. 375/240.1; 375/240.12

(57) ABSTRACT

A system and method for enabling the removal of decoded pictures from a decoded picture buffer as soon as the decoded pictures are no longer needed for prediction reference and future output. An indication is introduced into the bitstream as to whether a picture may be used for inter-layer prediction reference, as well as a decoded picture buffer management method which uses the indication. The present invention includes a process for marking a picture as being used for inter-layer reference or unused for inter-layer reference, a storage process of decoded pictures into the decoded picture buffer, a marking process of reference pictures, and output and removal processes of decoded pictures from the decoded picture buffer.

### FIELD OF THE INVENTION

The present invention relates to the field of video coding. More particularly, the present invention relates to scalable video coding.

### BACKGROUND OF THE INVENTION

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also know as ISO/IEC MPEG-4 AVC). In addition, there are currently efforts underway with regards to the development of new video coding standards. One such standard under development is the scalable video coding (SVC) standard, which will become the scalable extension to H.264/AVC. Another such effort involves the development of China video coding standards.

Scalable video coding can provide scalable video bitstreams. A portion of a scalable video bitstream can be extracted and decoded with a degraded playback visual quality. In today's concepts, a scalable video bitstream contains a non-scalable base layer and one or more enhancement layers. An enhancement layer may enhance the temporal resolution (i.e. the frame rate), the spatial resolution, or simply the quality of the video content represented by the lower layer or part thereof. In some cases, data of an enhancement layer can be truncated after a certain location, even at arbitrary positions, and each truncation position can include some additional data representing increasingly enhanced visual quality. Such scalability is referred to as fine-grained (granularity) scalability (FGS). In contrast to FGS, the scalability provided by a quality enhancement layer that does not provide fined-grained scalability is referred as coarse-grained scalability (CGS). Base layers can be designed to be FGS scalable as well; however, no current video compression standard or draft standard implements this concept.

The scalable layer structure in the current draft SVC standard is characterized by three variables, referred to as temporal_level, dependency_id and quality_level, that are signaled in the bit stream or can be derived according to the specification. temporal_level is used to indicate the temporal scalability or frame rate. A layer comprising pictures of a smaller temporal_level value has a smaller frame rate than a layer comprising pictures of a larger temporal_level. dependency_id is used to indicate the inter-layer coding dependency hierarchy. At any temporal location, a picture of a smaller dependency_id value may be used for inter-layer prediction for coding of a picture with a larger dependency_id value. quality_level is used to indicate FGS layer hierarchy. At any temporal location and with identical dependency_id value, an FGS picture with quality_level value equal to QL uses the FGS picture or base quality picture (i.e., the non-FGS picture when QL−1=0) with quality_level value equal to QL−1 for inter-layer prediction.

FIG. 1 depicts a temporal segment of an exemplary scalable video stream with the displayed values of the three variables discussed above. It should be noted that the time values are relative, i.e. time=0 does not necessarily mean the time of the first picture in display order in the bit stream. A typical prediction reference relationship of the example is shown in FIG. 2, where solid arrows indicate the interprediction reference relationship in the horizontal direction, and dashed block arrows indicate the inter-layer prediction reference relationship. The pointed-to instance uses the instance in the other direction for prediction reference.

As discussed herein, a layer is defined as the set of pictures having identical values of temporal_level, dependency_id and quality_level, respectively. To decode and playback an enhancement layer, typically the lower layers including the base layer should also be available, because the lower layers may be directly or indirectly used for inter-layer prediction in the decoding of the enhancement layer. For example, in FIGS. 1 and 2, the pictures with (t, T, D, Q) equal to (0, 0, 0, 0) and (8, 0, 0, 0) belong to the base layer, which can be decoded independently of any enhancement layers. The picture with (t, T, D, Q) equal to (4, 1, 0, 0) belongs to an enhancement layer that doubles the frame rate of the base layer; the decoding of this layer needs the presence of the base layer pictures. The pictures with (t, T, D, Q) equal to (0, 0, 0, 1) and (8, 0, 0, 1) belong to an enhancement layer that enhances the quality and bit rate of the base layer in the FGS manner; the decoding of this layer also needs the presence of the base layer pictures.

In the current draft SVC standard, a coded picture in a spatial or CGS enhancement layer has an indication (i.e. the base_id_plus1 syntax element in the slice header) of the inter-layer prediction reference. Inter-layer prediction includes a coding mode, motion information and sample residual prediction. The use of inter-layer prediction can significantly improve the coding efficiency of enhancement layers. Inter-layer prediction always uses lower layers as the reference for prediction. In other words, a higher layer is never required for the decoding of a lower layer.

In a scalable video bitstream, an enhancement layer picture may freely select which a lower layer to use for inter-layer prediction. For example, if there are three layers, base_layer_0, CGS_layer_1, and spatial_layer_2, and they have the same frame rate, the enhancement layer picture may select any of these layers for inter-layer prediction.

A typical inter-layer prediction dependency hierarchy is shown in FIG. 3. Referring to FIG. 3, the inter-layer prediction is expressed by arrows, which point in the direction of dependency. A pointed-to object requires the pointed-from object for inter-layer prediction. Still referring to FIG. 3, the pair of values in the right of each layer represents the values of the dependency_id and quality_level as specified in the current draft SVC standard. However, a picture in spatial_layer_2 may also select to use_base_layer_0 for inter-layer prediction, as shown in FIG. 4. Furthermore, it is possible that a picture in spatial_layer_{—2} selects base_layer_0 for inter-layer prediction while, at the same temporal location, the picture in CGS_layer_1 decides not to have any inter-layer prediction at all, as shown in FIG. 5.

When FGS layers are involved, the inter-layer prediction for coding mode and motion information may be obtained from a base layer other than the inter-layer prediction for the sample residual. For example and as shown in FIG. 6, for the spatial_layer_2 picture, the inter-layer prediction for coding mode and motion information stems from the CGS_layer_1 picture, whereas the inter-layer prediction for sample residual is obtained from the FGS_layer_1_1 picture. For another example and as shown in FIG. 7, for the spatial_layer_2 picture, the inter-layer prediction for coding mode and motion still is obtained from the CGS_layer_1 picture, whereas the inter-layer prediction of the sample residual stems from the FGS_layer_1_0 picture. The above relationship can, more abstractly, be expressed such that the inter-layer prediction for coding mode, motion information and sample residual all be obtained from the same FGS layer, as shown in FIGS. 8 and 9, respectively.

In video coding standards, a bit stream is defined as compliant when it can be decoded by a hypothetical reference decoder that is conceptually connected to the output of an encoder, and comprises at least a pre-decoder buffer, a decoder, and an output/display unit. This virtual decoder is known as the hypothetical reference decoder (HRD) in H.263, H.264 and the video buffering verifier (VBV) in MPEG. PSS Annex G. The Annex G of the 3GPP packet-switched streaming service standard (3GPP TS 26.234), specifies a server buffering verifier that can also be considered as an HRD, with the difference that it is conceptually connected to the output of a streaming server. Technologies such as the virtual decoder and buffering verifier are collectively referred to as hypothetical reference decoder (HRD) throughout herein. A stream is compliant if it can be decoded by the HRD without buffer overflow or underflow. Buffer overflow occurs if more bits are to be placed into the buffer when it is already full. Buffer underflow occurs if the buffer is empty at a time when bits are to be fetched from the buffer for decoding/playback.

HRD parameters can be used to impose constraints to the encoded sizes of pictures and to assist in deciding the required buffer sizes and start-up delay.

In earlier HRD specifications before PSS Annex G and H.264, only the operation of the pre-decoded buffer is specified. This buffer is normally called a coded picture buffer, CPB, in H.264. The HRD in PSS Annex G and H.264 HRD also specifies the operation of the post-decoder buffer (also called as a decoded picture buffer, DBP, in H.264). Furthermore, earlier HRD specifications enable only one HRD operation point, while the HRD in PSS Annex G and H.264 HRD allows for multiple HRD operation points. Each HRD operation point corresponds to a set of HRD parameter values.

According to the draft SVC standard, decoded pictures used for predicting subsequent coded pictures and for future output are buffered in the decoded picture buffer (DPB). To efficiently utilize the buffer memory, the DPB management processes, including the storage process of decoded pictures into the DPB, the marking process of reference pictures, output and removal processes of decoded pictures from the DPB, are specified.

The DPB management processes specified in the current draft SVC standard cannot efficiently handle the management of decoded pictures that require to be buffered for inter-layer prediction, particularly when those pictures are non-reference pictures. This is due to the fact that the DPB management processes were intended for traditional single-layer coding which supports, at most, temporal scalability.

In traditional single-layer coding such as in H.264/AVC, decoded pictures that must be buffered for inter prediction reference or future output can be removed from the buffer when they are no longer needed for inter prediction reference and future output. To enable the removal of a reference picture as soon as it becomes no longer necessary for inter prediction reference and future output, the reference picture marking process is specified such that it can be known as soon as a reference picture becomes no longer needed for inter prediction reference. However, for pictures for inter-layer prediction reference, there is currently no mechanism available that helps the decoder to obtain, as soon as possible, the information of a picture becoming no longer necessary for inter-layer prediction reference. One such method may involve removing all pictures in the DPB for which all of the following conditions are true from the DPB after decoding each picture in the desired scalable layer: 1) the picture is a non-reference picture; 2) the picture is in the same access unit as the just decoded picture; and 3) the picture is in a layer lower than the desired scalable layer. Consequently, pictures for inter-layer prediction reference may be unnecessarily buffered in the DPB, which reduces the efficiency of the buffer memory usage. For example, the required DPB may be larger than technically necessary.

In addition, in scalable video coding, decoded pictures of any scalable layer that is lower than the scalable layer desired for playback is never output. Storage of such pictures in the DPB, when they are not needed for inter prediction or inter-layer prediction, is simply a waste of the buffer memory.

It would therefore be desirable to provide a system and method for removing decoded pictures from the DPB as soon as they are no longer needed for prediction (inter prediction or inter-layer prediction) reference and future output.

### SUMMARY OF THE INVENTION

The present invention provides a system and method for enabling the removal of decoded pictures from the DPB as soon as they are no longer needed for inter prediction reference, inter-layer prediction reference and future output. The system and method of the present invention includes the introduction of an indication into the bitstream as to whether a picture may be used for inter-layer prediction reference, as well as a DPB management method which uses the indication. The DPB management method includes a process for marking a picture as being used for inter-layer reference or unused for inter-layer reference, the storage process of decoded pictures into the DPB, the marking process of reference pictures, and output and removal processes of decoded pictures from the DPB. To enable the marking of a picture as unused for inter-layer reference such that the decoder can know as soon as a a picture becomes no longer needed for inter-layer prediction reference, a new memory management control operation (MMCO) is defined, and the corresponding signaling in the bitstream is specified.

The present invention enables the provision of a decoded picture buffer management process that can save required memory for decoding of scalable video bitstreams. The present invention may be used within the context of the scalable extension of H.264/AVC video coding standard, as well as other scalable video coding methods.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows a temporal segment of an exemplary scalable video stream with the displayed values of the three variables temporal_level, dependency_id and qualit_level;

FIG. 2 is a typical prediction reference relationship for the temporal segment depicted in FIG. 1;

FIG. 3 is a representation of a typical inter-layer prediction dependency hierarchy, where an arrow indicates that the pointed-to object uses the pointed-from object for inter-layer prediction reference;

FIG. 4 is a flow chart showing how, a picture in a spatial_layer_2 may also select to use base_layer_0 for inter-layer prediction;

FIG. 5 is a representation of an example where a picture in a spatial_layer_2 selects base_layer_0 for inter-layer prediction while, at the same temporal location, the picture in CGS_layer_1 decides not to have any inter-layer prediction;

FIG. 6 is a representation of an example showing how the inter-layer prediction for coding mode and motion information may come from a different base layer than the inter-layer prediction for the sample residual;

FIG. 7 is an example showing how for the spatial_layer_2 picture, the inter-layer prediction for coding mode and motion can comes from a CGS_layer_1 picture, while the inter-layer prediction for sample residual comes from a FGS_layer_1_0 picture;

FIG. 8 is a representation of an example where inter-layer prediction for coding mode, motion information and sample residual all comes from the a FGS_layer_1_1 picture, where the coding mode and motion information are inherited from the base quality layer;

FIG. 9 is a representation of an example where inter-layer prediction for coding mode, motion information and sample residual all comes from the a FGS_layer_1_0 picture, where the coding mode and motion information are inherited from the base quality layer;

FIG. 10 shows an example of the status evolving process for a number of coded pictures in an access unit according to conventionally-known systems;

FIG. 11 shows an example of the status evolving process for a number of coded pictures in an access unit according to system and method of the present invention;

FIG. 12 is an overview diagram of a system within which the present invention may be implemented;

FIG. 13 is a perspective view of an electronic device that can incorporate the principles of the present invention;

FIG. 14 is a schematic representation of the circuitry of the electronic device of FIG. 13; and

FIG. 15 is an illustration of a common multimedia data streaming system in which the scalable coding hierarchy of the invention can be applied

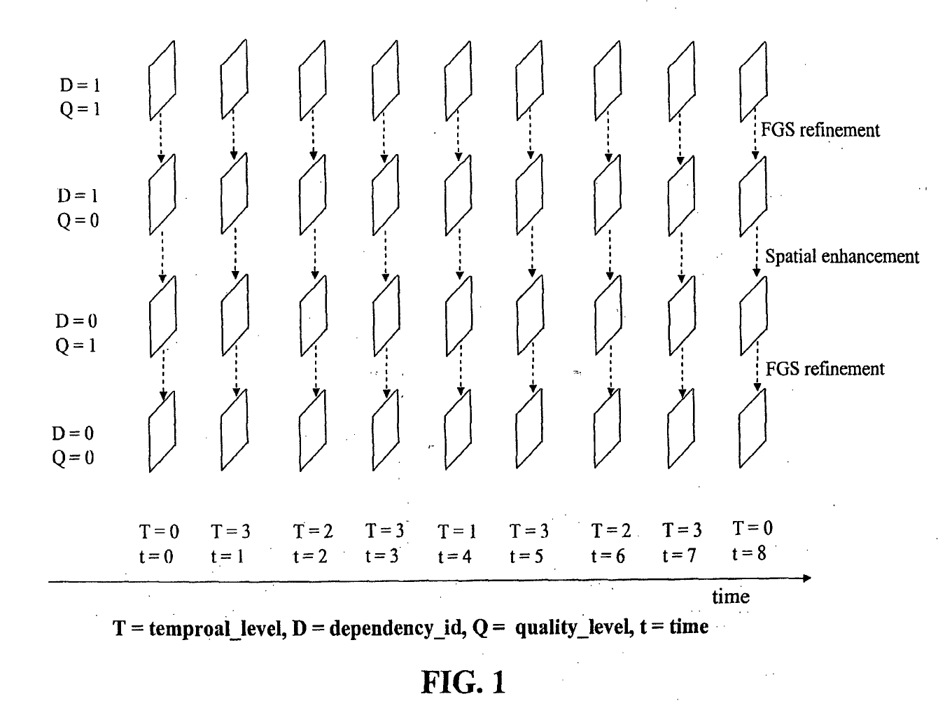

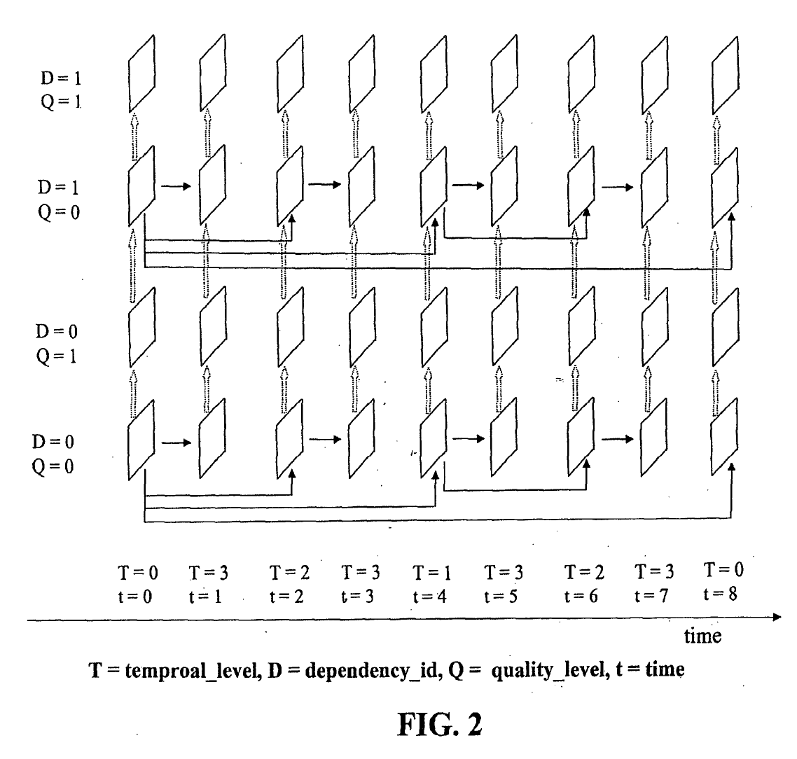

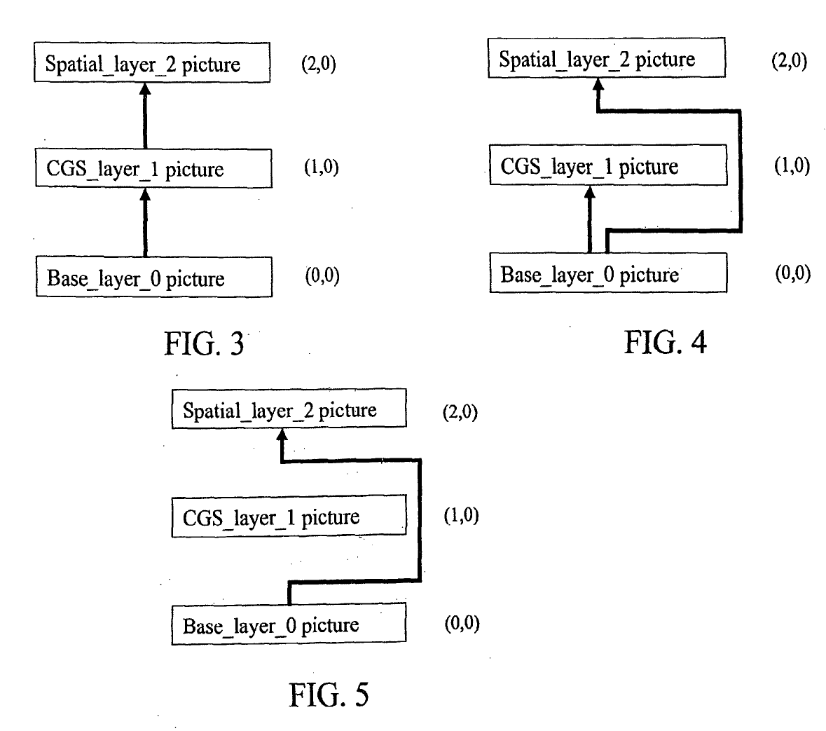

### DETAILED DESCRIPTION OF THE PREFERRED EMBODIMENTS

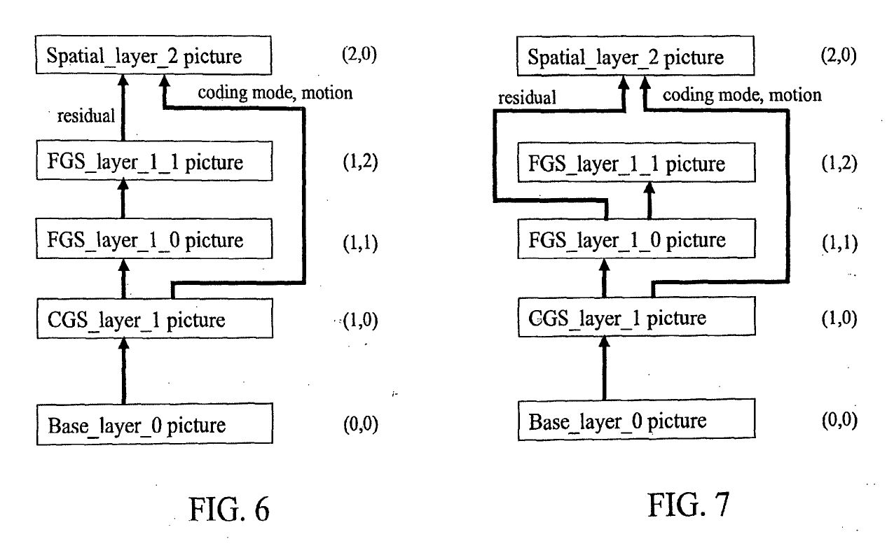

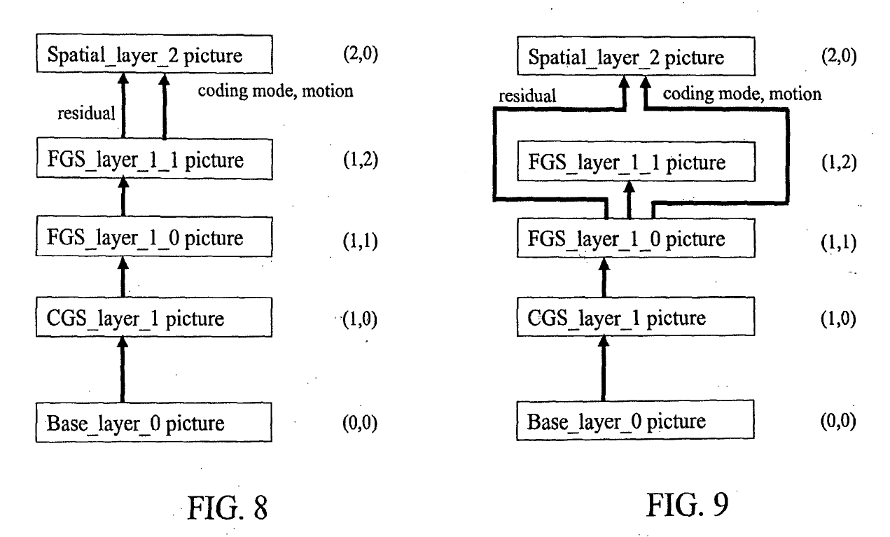

With reference to FIG. 6, a typical multimedia streaming system is described, which is one system for applying the procedure of the present invention.

A multimedia data streaming system typically comprises one or more multimedia sources 100, such as a video camera and a microphone, or video image or computer graphic files stored in a memory carrier. Raw data obtained from the different multimedia sources 100 is combined into a multimedia file in an encoder 102, which can also be referred to as an editing unit. The raw data arriving from the one or more multimedia sources 100 is first captured using capturing means 104 included in the encoder 102, which capturing means can be typically implemented as different interface cards, driver software, or application software controlling the function of a card. For example, video data may be captured using a video capture card and the associated software. The output of the capturing means 104 is typically either an uncompressed or slightly compressed data flow, for example uncompressed video frames of the YUV 4:2:0 format or motion-JPEG image format, when a video capture card is concerned.

An editor 106 links different media flows together to synchronize video and audio flows to be reproduced simultaneously as desired. The editor 106 may also edit each media flow, such as a video flow, by halving the frame rate or by reducing spatial resolution, for example. The separate, although synchronized, media flows are compressed in a compressor 108, where each media flow is separately compressed using a compressor suitable for the media flow. For example, video frames of the YUV 4:2:0 format may be compressed using the ITU-T recommendation H.263 or H.264. The separate, synchronized and compressed media flows are typically interleaved in a multiplexer 110, the output obtained from the encoder 102 being a single, uniform bit flow that comprises data of a plural number of media flows and that may be referred to as a multimedia file. It is to be noted that the forming of a multimedia file does not necessarily require the multiplexing of a plural number of media flows into a single file, but the streaming server may interleave the media flows just before transmitting them.

The multimedia files are transferred to a streaming server 112, which is thus capable of carrying out the streaming either as real-time streaming or in the form of progressive downloading. In progressive downloading the multimedia files are first stored in the memory of the server 112 from where they may be retrieved for transmission as need arises. In real-time streaming the editor 102 transmits a continuous media flow of multimedia files to the streaming server 112, and the server 112 forwards the flow directly to a client 114. As a further option, real-time streaming may also be carried out such that the multimedia files are stored in a storage that is accessible from the server 112, from where real-time streaming can be driven and a continuous media flow of multimedia files is started as need arises. In such case, the editor 102 does not necessarily control the streaming by any means. The streaming server 112 carries out traffic shaping of the multimedia data as regards the bandwidth available or the maximum decoding and playback rate of the client 114, the streaming server being able to adjust the bit rate of the media flow for example by leaving out B-frames from the transmission or by adjusting the number of the scalability layers. Further, the streaming server 112 may modify the header fields of a multiplexed media flow to reduce their size and encapsulate the multimedia data into data packets that are suitable for transmission in the telecommunications network employed. The client 114 may typically adjust, at least to some extent, the operation of the server 112 by using a suitable control protocol. The client 114 is capable of controlling the server 112 at least in such a way that a desired multimedia file can be selected for transmission to the client, in addition to which the client is typically capable of stopping and interrupting the transmission of a multimedia file.

The following text describes one particular embodiment of the present invention in the form of specification text for a SVC standard. In this embodiment, decoded reference picture marking syntax is as follows.

Decoded Reference Picture Marking Syntax

| | | |
|---|---|---|
| dec_ref_pic_marking( ) { | C | Descriptor |

if( nal_ref_idc != 0) {

if( nal_unit_type == 5 ∥ nal_unit_type == 21 ) {

| | | |
|---|---|---|
| no_output_of_prior_pics_flag | 2\|5 | u(1) |
| long_term_reference_flag | 2\|5 | u(1) |

} else {

| | | |
|---|---|---|
| adaptive_ref_pic_marking_mode_flag | 2\|5 | u(1) |
| if( adaptive_ref_pic_marking_mode_flag ) | | |

do {

| | | |
|---|---|---|
| memory_management_control_operation | 2\|5 | ue(v) |
| if( memory_management_control_operation == 1 \|\| | | |

memory_management_control_operation == 3 )

| | | |
|---|---|---|
| difference_of_pic_nums_minus1 | 2\|5 | ue(v) |
| if(memory_management_control_operation == 2 ) | | |

| | | |
|---|---|---|
| long_term_pic_num | 2\|5 | ue(v) |

if( memory_management_control_operation == 3 ||

memory_management_control_operation == 6 )

| | | |
|---|---|---|
| long_term_frame_idx | 2\|5 | ue(v) |

if( memory_management_control_operation == 4 )

| | | |
|---|---|---|
| max_long_term_frame_idx_plus1 | 2\|5 | ue(v) |

} while( memory_management_control_operation != 0 )

}

}
If( inter_layer_ref_flag) {

| | | |
|---|---|---|
| num_inter_layer_mmco | 2\|5 | ue(v) |
| if( num_inter_layer_mmco > 0 ) { | | |

for( i = 0; i < num_inter_layer_mmco; i++ ) {

| | | |
|---|---|---|
| dependency_id[ i ] | 2\|5 | u(3) |
| quality_level[ i ] | 2\|5 | u(2) |

}

}

}

}

The slice header in scalable extension syntax is as follows.

Slice Header In Scalable Extension Syntax

| slice_header_in_scalable_extension( ) { | | C | Descriptor |
|---|---|---|---|
| | first_mb_in_slice | 2 | ue(v) |
| | slice_type | 2 | ue(v) |

| if( slice_type == PR ) { | | |
|---|---|---|
| fragmented_flag | 2 | u(1) |
| if ( fragmented_flag == 1 ) { | | |

| | | |
|---|---|---|
| fragment_order | 2 | ue(v) |
| if ( fragment_order != 0) | | |

| | | |
|---|---|---|
| last_fragment_flag | 2 | u(1) |

}
if ( fragment_order == 0 ) {

| | | |
|---|---|---|
| num_mbs_in_slice_minus1 | 2 | ue(v) |
| luma_chroma_sep_flag | 2 | u(1) |

}

}
if ( slice_type != PR || fragment_order == 0 ) {

| | | |
|---|---|---|
| pic_parameter_set_id | 2 | ue(v) |
| frame_num | 2 | u(v) |
| inter_layer_ref_flag | 2 | u(1) |
| if( !frame_mbs_only_flag ) { | | |

| | | |
|---|---|---|
| field_pic_flag | 2 | u(1) |
| if( field_pic_flag ) | | |

| | | |
|---|---|---|
| bottom_field_flag | 2 | u(1) |

}
if( nal_unit_type == 21 )

| | | |
|---|---|---|
| idr_pic_id | 2 | ue(v) |

if( pic_order_cnt_type == 0 ) {

| | | |
|---|---|---|
| pic_order_cnt_lsb | 2 | u(v) |
| if( pic_order_present_flag && !field_pic_flag ) | | |

| | | |
|---|---|---|
| delta_pic_order_cnt_bottom | 2 | se(v) |

}
if( pic_order_cnt_type == 1 && !delta_pic_order_always_zero_flag ) {

| | | |
|---|---|---|
| delta_pic_order_cnt[ 0 ] | 2 | se(v) |
| if( pic_order_present_flag && !field_pic_flag ) | | |

| | | |
|---|---|---|
| delta_pic_order_cnt[ 1 ] | 2 | se(v) |

}

}
if( slice_type != PR ) {

if( redundant_pic_cnt_present_flag )

| | | |
|---|---|---|
| redundant_pic_cnt | 2 | ue(v) |

if( slice_type == EB )

| | | |
|---|---|---|
| direct_spatial_mv_pred_flag | 2 | u(1) |

| | | |
|---|---|---|
| number_of_update_level | 2 | ue(v) |

| | | |
|---|---|---|
| base_id_plus1 | 2 | ue(v) |
| if( base_id_plus1 != 0 ) { | | |

| | | |
|---|---|---|
| adaptive_prediction_flag | 2 | u(1) |

}
if( slice_type == EP || slice_type == EB ) {

| | | |
|---|---|---|
| num_ref_idx_active_override_flag | 2 | u(1) |
| if( num_ref_idx_active_override_flag ) { | | |

| | | |
|---|---|---|
| num_ref_idx_10_active_minus_1 | 2 | ue(v) |
| if( slice_type == EB ) | | |

| | | |
|---|---|---|
| num_ref_idx_11_active_minus1 | 2 | ue(v) |

}

| } | |
|---|---|
| ref_pic_list_reordering( ) | 2 |
| if ( number_of_update_level > 0 ) { | |

| | | |
|---|---|---|
| num_ref_idx_update_active_override_flag | 2 | u(1) |
| if (num_ref_idx_update_active_override_flag) | | |

for( decLvl = 0; decLvl < number_of_update_level; decLvl++ ) {

| | | |
|---|---|---|
| num_ref_idx_update_10_active[ decLvl + 1 + temporal_level ] | 2 | ue(v) |
| num_ref_idx_update_11_active[ decLvl + 1 + temporal_level ] | 2 | ue(v) |

}

else

for( decLvl = 0; decLvl < number_of_update_level; decLvl++ ) {

num_ref_idx_update_10_active[ decLvl + 1 +temporal_level]=

num_ref_idx_update_10_active_default

num_ref_idx_update_11_active[ decLvl + 1 +temporal_level]=

num_ref_idx_update_11_active_default

}

}
if( ( weighted_pred_flag && slice_type == EP ) ||

( weighted_bipred_idc == 1 && slice_type == EB ) ) {
if( adaptive_prediction_flag)

| | | |
|---|---|---|
| base_pred_weight_table_flag | 2 | u(1) |

if( base_pred_weight_table_flag == 0 )
pred_weight_table( )

}
if( nal_ref_idc != 0 || inter_layer_ref_flag )

| | |
|---|---|
| dec_ref_pic_marking( ) | 2 |

if( entropy_coding_mode_flag && slice_type != EI )

| | | |
|---|---|---|
| cabac_init_idc | 2 | ue(v) |

}
if( slice_type != PR || fragment_order == 0 ) {

| | | |
|---|---|---|
| slice_qp_delta | 2 | se(v) |
| if( deblocking_filter_control_present_flag ) { | | |

| | | |
|---|---|---|
| disable_deblocking_filter_idc | 2 | ue(v) |
| if( disable_deblocking_filter_idc != 1 ) { | | |

| | | |
|---|---|---|
| slice_alpha_c0_offset_div2 | 2 | se(v) |
| slice_beta_offset_div2 | 2 | se(v) |

}

}

}
if( slice_type != PR )

if( num_slice_groups_minus1 > 0 &&

| slice_group_map_type >= 3 && slice_group_map_type <= 5) | | |
|---|---|---|
| slice_group_change_cycle | 2 | u(v) |

if( slice_type != PR && extended_spatial_scalability > 0 ) {

if ( chroma_format_idc > 0 ) {

| | | |
|---|---|---|
| base_chroma_phase_x_plus1 | 2 | u(2) |
| base_chroma_phase_y_plus1 | 2 | u(2) |

}
if( extended_spatial_scalability == 2 ) {

| | | |
|---|---|---|
| scaled_base_left_offset | 2 | se(v) |
| scaled_base_top_offset | 2 | se(v) |
| scaled_base_right_offset | 2 | se(v) |
| scaled_base_bottom_offset | 2 | se(v) |

}

}
SpatialScalabilityType = spatial_scalability_type( )

}

For decoded reference picture marking semantics, “num_inter_layer_mmco” indicates the number of memory_management_control operations to mark decoded pictures in the DPB as “unused for inter-layer prediction”. “dependency_id[i]” indicates the dependency_id of the picture to be marked as “unused for inter-layer prediction”. dependency_id[i] is smaller than or equal to the dependency id of the current picture. “quality_level[i]” indicates the quality_level of the picture to be marked as “unused for inter-layer prediction”. When dependency_id[i] is equal to dependency_id, quality_level[i] is smaller than quality_level. The decoded picture in the same access unit as the current picture and having dependency_id equal to dependency_id[i] and quality_level equal to quality_level[i] will have an inter_layer_ref_flag equal to 1.

When present, the value of the slice header in scalable extension syntax elements pic_parameter_set_id, frame_num, inter_layer_ref_flag, field_pic_flag, bottom_field_flag, idr_pic_id, pic_order_cnt_1sb, delta_pic_order_cnt_bottom, delta_pic_order_cnt[0], delta_pic_order_cnt[1], and slice_group_change_cycle is the same in all slice headers of a coded picture. “frame_num” has the same semantics as frame_num in subclause S.7.4.3 in the current draft SVC standard. An “inter_layer_ref_flag” value equal to 0 indicates that the current picture is not used for inter-layer prediction reference for decoding of any picture with a greater value of dependency_id than the value of dependency_id for the current picture. An “inter_layer_ref_flag” value equal to 1 indicates that the current picture may be used for inter-layer prediction reference for decoding of a picture with a larger value of dependency_id than the current picture. The “field_pic_flag” has the same semantics as field_pic_flag in subclause S.7.4.3 of the current draft SVC standard.

For the sequence of operations for decoded picture marking process, when the value of “inter_layer_ref_flag” is equal to 1, the current picture is marked as “used for inter-layer reference”.

For the process for marking a picture as “unused for inter-layer reference,” this process is invoked when the value for “num_inter_layer_mmco” is not equal to 0. All pictures in the DPB, for which all the following conditions are true are marked as “unused for inter-layer reference”: (1) the picture belongs to the same access unit as the current picture; (2) the picture has an “inter_layer_ref flag” value equal to 1 and is marked as “used for inter-layer reference”; (3) the picture has values for dependency_id and quality_level equal to one pair of dependency_id[i] and quality_level[i] signaled in the syntax of dec_ref Pic_marking( ) for the current picture; and (4) the picture is a non-reference picture.

For the operation of the decoded picture buffer, the decoded picture buffer contains frame buffers. Each of the frame buffers may contain a decoded frame, a decoded complementary field pair or a single (non-paired) decoded field that are marked as “used for reference” (reference pictures), are marked as “used for inter-layer reference” or are held for future output (reordered or delayed pictures). Prior to initialization, the DPB is empty (the DPB fullness is set to zero). The following steps of the subclauses of this subclause all happen instantaneously at tᵣ(n) and in the sequence listed.

For the decoding of gaps in frame_num and storage of “non-existing” frames, if applicable, gaps in frame_num are detected by the decoding process, and the generated frames are marked and inserted into the DPB as specified as follows. Gaps in frame_num are detected by the decoding process and the generated frames are marked as specified in subclause 8.2.5.2 of the current draft SVC standard. After the marking of each generated frame, each picture m marked by the “sliding window” process as “unused for reference” is removed from the DPB when it is also marked as “non-existing” or its DPB output time is less than or equal to the coded picture buffer (CPB) removal time of the current picture n; i.e., t_{o,dpb}(m)<=tᵣ(n). When a frame or the last field in a frame buffer is removed from the DPB, the DPB fullness is decremented by one. The “non-existing” generated frame is inserted into the DPB and the DPB fullness is incremented by one.

For picture decoding and output, a picture n is decoded and temporarily stored (not in the DPB). If picture n is in the desired scalable layer, the following text applies. The DPB output time t_{o,dpb}(n) of picture n is derived by t_{o,dpb}(n)=tᵣ(n)+t_{c}*dpb_output_delay(n). The output of the current picture is specified as follows. If t_{o,dpb}(n)=tᵣ(n), the current picture is output. It should be noted that when the current picture is a reference picture, it will be stored in the DPB. If t_{o,dpb}(n)≢tᵣ(n), then t_{o,dpb}(n)>tᵣ(n) ), the current picture is output later and will be stored in the DPB (as specified in subclause C.2.4 of the current draft SVC standard) and is output at time t_{o,dpb}(n) unless indicated not to be output by the decoding or inference of no_output_of prior_pics_flag equal to 1 at a time that precedes t_{o,dpb}(n). The output picture is cropped, using the cropping rectangle specified in the sequence parameter set for the sequence.

When picture n is a picture that is output and is not the last picture of the bitstream that is output, the value of Δt_{o,dpb}(n) is defined as Δt_{o,dpb}(n)=t_{o,dpb}(nₙ)−t_{o,dpb}(n), where nₙ indicates the picture that follows after picture n in output order.

The removal of pictures from the DPB before possible insertion of the current picture proceeds as follows and in the sequence listed. If the decoded picture is an IDR picture, then the following applies. All reference pictures in the DPB and having identical values of dependency_id and quality_level, respectively, as the current picture are marked as “unused for reference” as specified in subclause 8.2.5.1 of the current draft SVC standard. When the IDR picture is not the first IDR picture decoded and the value of PicWidthInMbs or FrameHeightInMbs or max_dec_frame_buffering derived from the active sequence parameter set is different from the value of PicWidthInMbs or FrameHeightInMbs or max_dec_frame_buffering derived from the sequence parameter set that was active for the preceding sequence having identical values of dependency_id and quality_level as the current coded video sequence, respectively, no_output_of prior_pics_flag is inferred to be equal to 1 by the HRD, regardless of the actual value of no_output_of_prior_pics_flag. It should be noted that decoder implementations should attempt to handle frame or DPB size changes more gracefully than the HRD in regard to changes in PicWidthInMbs or FrameHeightInMbs.

When no_output_of prior_pics_flag is equal to 1 or is inferred to be equal to 1, all frame buffers in the DPB containing decoded pictures having identical values of dependency_id and quality_level, respectively, as the current picture are emptied without output of the pictures they contain, and DPB fullness is decreased by the number of emptied frame buffers. Otherwise (i.e., where the decoded picture is not an IDR picture), the following applies. If the slice header of the current picture includes a memory_management_control_operation value equal to 5, all reference pictures in the DPB and having identical values of dependency_id and quality_level, respectively, as the current picture are marked as “unused for reference”. Otherwise (i.e., the slice header of the current picture does not include a memory_management_control_operation value equal to 5), the decoded reference picture marking process specified in subclause 8.2.5 of the current draft SVC standard is invoked. The marking process of a picture as “unused for inter-layer reference” as specified in subclause 8.2.5.5 of the current draft SVC standard is invoked.

If the current picture is in the desired scalable layer, all decoded pictures in the DPB satisfying all of the following conditions are marked as “unused for inter-layer reference”. (1) The picture belongs to the same access unit as the current picture; (2) the picture has a inter_layer_ref flag value equal to 1 and is marked as “used for inter-layer reference”; and (3) the picture has a smaller value of dependency_id than the current picture or identical value of dependency_id but a smaller value of quality_level than the current picture.

All pictures m in the DPB, for which all of the following conditions are true, are removed from the DPB. (1) Picture m is marked as “unused for reference” or picture m is a non-reference picture. When a picture is a reference frame, it is considered to be marked as “unused for reference” only when both of its fields have been marked as “unused for reference”. (2) Picture m is marked as “unused for inter-layer reference” or picture m has inter_layer_ref flag equal to 0. (3) Picture m is either marked as “non-existing”, it is not in the desired scalable layer, or its DPB output time is less than or equal to the CPB removal time of the current picture n; i.e., t_{o,dpb}(m)<=tᵣ(n). When a frame or the last field in a frame buffer is removed from the DPB, the DPB fullness is decremented by one.

The following is a discussion of the current decoded picture marking and storage. For the marking and storage of a reference decoded picture into the DPB, when the current picture is a reference picture, it is stored in the DPB as follows. If the current decoded picture is a second field (in decoding order) of a complementary reference field pair, and the first field of the pair is still in the DPB, the current decoded picture is stored in the same frame buffer as the first field of the pair. Otherwise, the current decoded picture is stored in an empty frame buffer, and the DPB fullness is incremented by one.

For the storage of a non-reference picture into the DPB, when the current picture is a non-reference picture the following applies. If the current picture is not in the desired scalable layer, or if the current picture is in the desired scalable layer and it has t_{o,dpb}(n)>tᵣ(n), it is stored in the DPB as follows. If the current decoded picture is a second field (in decoding order) of a complementary non-reference field pair, and the first field of the pair is still in the DPB, the current decoded picture is stored in the same frame buffer as the first field of the pair. Otherwise, the current decoded picture is stored in an empty frame buffer, and the DPB fullness is incremented by one.

In the embodiment discussed above, the indication telling whether a picture may be used for inter-layer prediction reference is signaled in the slice header. This is signaled as the syntax element inter_layer_ref_flag. There are a number alternative ways for signaling of the indication. For example, the indication can be signaled in the NAL unit header or in other ways.

The signaling of the memory management operation command (MMCO) can also be performed in alternative ways so long as the pictures to be marked as unused for inter-layer reference can be identified. For example, the syntax element dependency_id[i] can be coded as a delta in relative to the dependency_id value of the current picture to which the slice header belongs.

The primary differences between the above-discussed embodiment and the original DPB management process are as follows. (1) In the embodiment discussed above, the decoded picture is marked as used for inter-layer reference” when inter_layer_ref_flag is equal to 1. (2) The decoded picture output process in the above embodiment is specified only when the picture is in the desired scalable layer. (3) The process for marking a picture as “unused for inter-layer reference” in the above embodiment is invoked before the removal of pictures from the DPB before possible insertion of the current picture. (4) The condition for pictures to be removed from the DPB before possible insertion of the current picture in the above embodiment is changed, such that whether the picture is marked as “unused for inter-layer reference” or has inter_layer_ref_flag equal to 0, and whether the picture is in the desired scalable layer are taken into account. (5) The condition for pictures to be stored into the DPB is changed in the above embodiment, taking into account whether the picture is in the desired scalable layer.

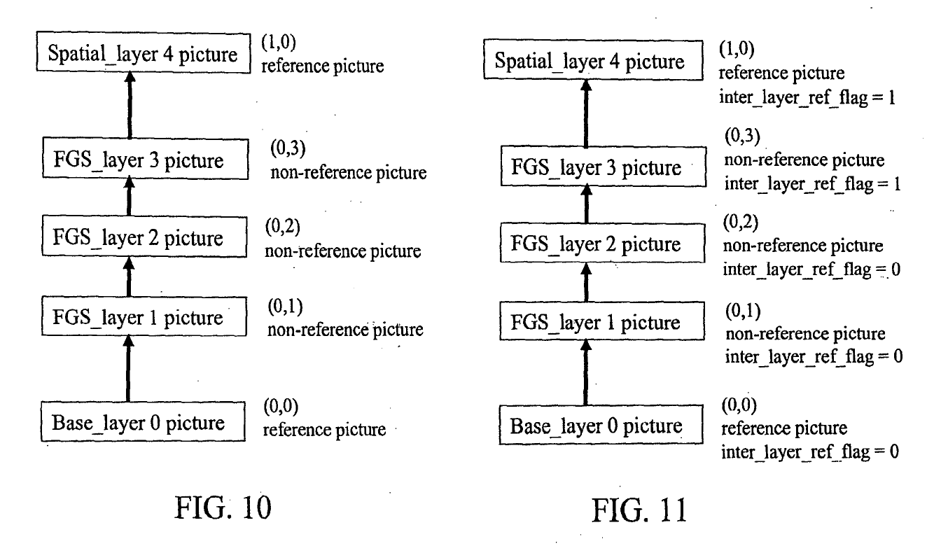

FIG. 10 shows an example of the status evolving process for a number of coded pictures in an access unit according to conventionally-known systems, and FIG. 11 shows the same example according to the present invention. The DPB status evolving process for the conventional system depicted in FIG. 10 is as follows (assuming that the layer 4 is the desired scalable layer for decoding and playback). Pictures from earlier decoded access units may also be stored in the DPB, but these pictures are not counted in below just for simplicity. After the decoding of the layer 0 picture and the corresponding DPB management process, the DPB contains only the picture from layer 0. After the decoding of the layer 1 picture and the corresponding DPB management process, the DPB contains the 2 pictures from layers 0 and 1, respectively. After the decoding of the layer 2 picture and the corresponding DPB management process, the DPB contains the 3 pictures from layers 0-2, respectively. After the decoding of the layer 3 picture and the corresponding DPB management process, the DPB contains the 4 pictures from layers 0-3, respectively. After the decoding of the layer 4 picture and the corresponding DPB management process, the DPB contains the 2 pictures from layers 0 and 4, respectively.

The DPB status evolving process as depicted in FIG. 11 is as follows (assuming that the layer 4 is the desired scalable layer for decoding and playback). Pictures from earlier decoded access units may also be stored in the DPB, but these pictures are not counted in below for simplicity purposes. After the decoding of the layer 0 picture and the corresponding DPB management process, the DPB contains only the picture from layer 0. After the decoding of the layer 1 picture and the corresponding DPB management process, the DPB contains the 2 pictures from layers 0 and 1, respectively. After the decoding of the layer 2 picture and the corresponding DPB management process, the DPB contains the 2 pictures from layers 0 and 2, respectively. After the decoding of the layer 3 picture and the corresponding DPB management process, the DPB contains the 2 pictures from layers 0 and 3, respectively. After the decoding of the layer 4 picture and the corresponding DPB management process, the DPB contains the 2 pictures from layers 0 and 4, respectively.

As can be seen in FIG. 11, the invention can reduce the requirement on buffer memory. In the example depicted in FIG. 11, buffer memory for 2 decoded pictures can be saved.

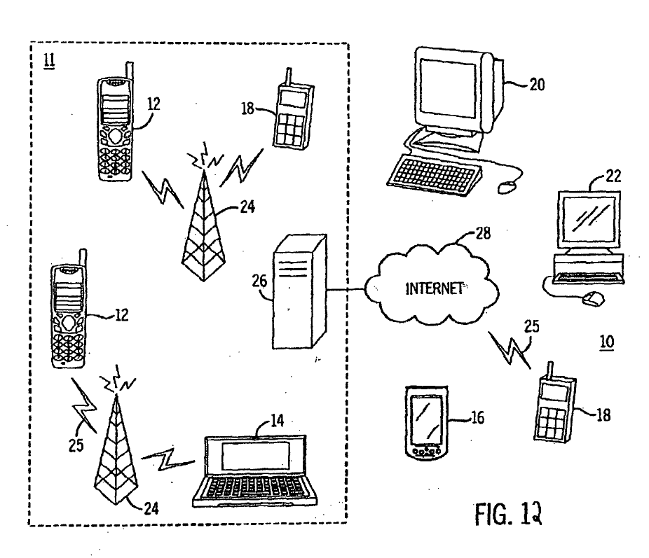

FIG. 12 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 12 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

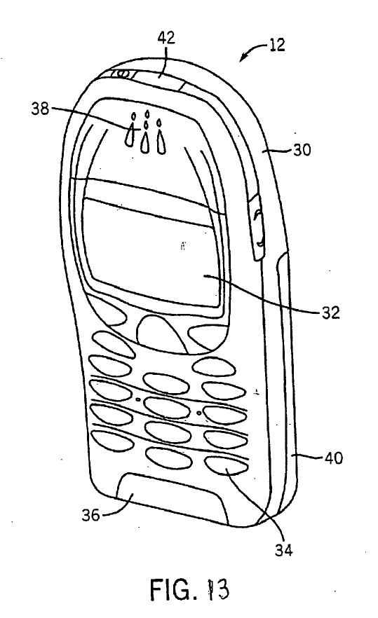

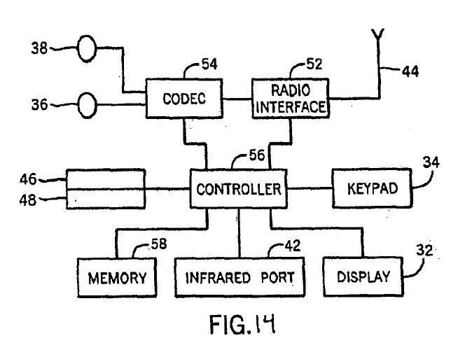

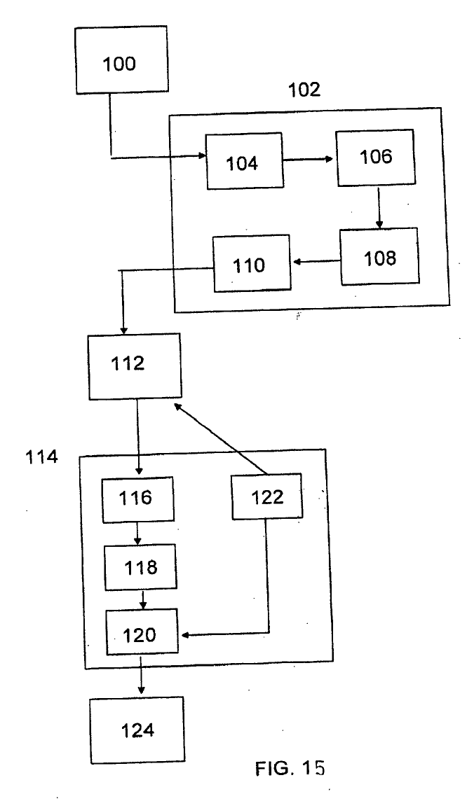

FIGS. 13 and 14 show one representative mobile telephone 12 within which the present invention may be implemented. It should be understood, however, that the present invention is not intended to be limited to one particular type of mobile telephone 12 or other electronic device. The mobile telephone 12 of FIGS. 13 and 14 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of managing a decoded picture buffer for scalable video coding, comprising:
receiving a first decoded picture belonging to a first layer in a bitstream into the decoded picture buffer;
receiving a second decoded picture belonging to a second layer;
determining whether the first decoded picture is required for inter-layer prediction reference in light of the receipt of the second decoded picture; and
if the first decoded picture is no longer required for inter-layer prediction reference, inter prediction reference and future output, removing the first decoded picture from the decoded picture buffer.

2. The method of claim 1, further comprising carrying information related to an indication of possible inter-layer prediction reference of a subsequent picture in decoding order signaled in the bitstream.

3. The method of claim 2, wherein the indication of possible inter-layer prediction reference is signaled in the slice header.

4. The method of claim 2, wherein the indication of possible inter-layer prediction reference is signaled in the Network Abstraction Layer (NAL) unit header.

5. The method of claim 2, wherein the determining of whether the first decoded picture is required for inter-layer prediction reference includes selectively marking the first decoded picture as “unused for inter-layer reference.”

6. The method of claim 5, wherein the first decoded picture is marked as “unused for inter-layer reference” if the first picture belongs to the same access unit as the second picture.

7. The method of claim 6, wherein the determining of whether the first decoded picture is marked as “unused for inter-layer reference” according to a signaling in the bitstream.

8. The method of claim 5, wherein the first decoded picture is marked as “unused for inter-layer reference” if the first picture has the indication of possible inter layer prediction reference being positive and is marked as “used for inter-layer reference”.

9. The method of claim 8, wherein the determining of whether the first decoded picture is marked as “unused for inter-layer reference” according to a signaling in the bitstream.

10. The method of claim 5, wherein the first decoded picture is marked as “unused for inter-layer reference” if the first picture has a smaller value of dependency_id than the second picture or identical value of dependency_id but a smaller value of quality_level than the second picture.

11. The method of claim 10, wherein the determining of whether the first decoded picture is marked as “unused for inter-layer reference” according to a signaling in the bitstream.

12. The method of claim 2, wherein the first decoded picture is determined to be no longer required for inter-layer prediction reference if the first picture is marked as “unused for reference” or a non-reference picture; if the first picture is marked as “unused for inter-layer reference” or has the indication of possible inter layer prediction reference being negative; and if the first picture is either marked as “non-existing” is not in the desired scalable layer or has a decoded picture buffer output time less than or equal to a coded picture buffer removal time of the second picture.

13. The method of claim 12, wherein, if the first decoded picture is a reference frame, the first decoded picture is considered to be marked as “unused for reference” only when both of the first decoded picture's fields have been marked as “unused for reference.”

14. The method of claim 1, wherein the first decoded picture is not needed for future output if the first decoded picture is not in the desired scalable layer for playback.

15. The method of claim 1, wherein the bitstream comprises a first sub-bitstream and a second sub-bitstream, the first sub-bitstream comprising coded pictures belonging to the first layer and the second sub bit stream comprising pictures of said second layer.

16. A decoder for decoding an encoded stream of a plurality of pictures, the plurality of pictures being defined as reference pictures or non-reference pictures, and information relating to decoding order and output order of a picture is defined for pictures of the picture stream, the decoder configured to perform the method of claim 1.

17. A computer program product for managing a decoded picture buffer for scalable video coding, comprising:
computer code for receiving a first decoded picture belonging to a first layer in a bitstream into the decoded picture buffer;
computer code for receiving a second decoded picture belonging to a second layer;
computer code for determining whether the first decoded picture is required for inter-layer prediction reference in light of the receipt of the second decoded picture; and
computer code for, if the first decoded picture is no longer required for inter-layer prediction reference, inter prediction reference and future output, removing the first decoded picture from the decoded picture buffer.

18. The computer program product of claim 17, further comprising computer code for carrying information related to an indication of possible inter-layer prediction reference of a subsequent picture in decoding order signaled in the bitstream.

19. The computer program product of claim 18, wherein the indication of possible inter-layer prediction reference is signaled in the slice header.

20. The computer program product of claim 18, wherein the indication of possible inter-layer prediction reference is signaled in the Network Abstraction Layer (NAL) unit header.

21. The computer program product of claim 18, wherein the determining of whether the first decoded picture is required for inter-layer prediction reference includes selectively marking the first decoded picture as “unused for inter-layer reference.”

22. The computer program product of claim 21, wherein the first decoded picture is marked as “unused for inter-layer reference” if the first picture belongs to the same access unit as the second picture.

23. The computer program product of claim 22, wherein the determining of whether the first decoded picture is marked as “unused for inter-layer reference” according to a signaling in the bitstream.

24. The computer program product of claim 21, wherein the first decoded picture is marked as “unused for inter-layer reference” if the first picture has the indication of possible inter layer prediction reference being positive and is marked as “used for inter-layer reference”.

25. The computer program product of claim 24, wherein the determining of whether the first decoded picture is marked as “unused for inter-layer reference” according to a signaling in the bitstream.

26. The computer program product of claim 21, wherein the first decoded picture is marked as “unused for inter-layer reference” if the first picture has a smaller value of dependency_id than the second picture or identical value of dependency_id but a smaller value of quality_level than the second picture.

27. The computer program product of claim 26, wherein the determining of whether the first decoded picture is marked as “unused for inter-layer reference” according to a signaling in the bitstream.

28. The computer program product of claim 17, wherein the first decoded picture is determined to be no longer required for inter-layer prediction reference if the first picture is marked as “unused for reference” or a non-reference picture; if the first picture is marked as “unused for inter-layer reference” or has the indication of possible inter layer prediction reference being negative; and if the first picture is either marked as “non-existing” is not in the desired scalable layer or has a decoded picture buffer output time less than or equal to a coded picture buffer removal time of the second picture.

29. The computer program product of claim 28, wherein, if the first decoded picture is a reference frame, the first decoded picture is considered to be marked as “unused for reference” only when both of the first decoded picture's fields have been marked as “unused for reference.”

30. The computer program product of claim 16, wherein the first decoded picture is not needed for future output if the first decoded picture is not in the desired scalable layer for playback.

31. The computer program product of claim 16, wherein the bitstream comprises a first sub-bitstream and a second sub-bitstream, the first sub-bitstream comprising coded pictures belonging to the first layer and the second sub bit stream comprising pictures of said second layer.

32. An electronic device, comprising:
a processor; and
a memory unit operatively connected to the processor and including a computer program product for managing a decoded picture buffer for scalable video coding, comprising:
computer code for receiving a first decoded picture belonging to a first layer in a bitstream into the decoded picture buffer;
computer code for receiving a second decoded picture belonging to a second layer;
computer code for determining whether the first decoded picture is required for inter-layer prediction reference in light of the receipt of the second decoded picture; and
computer code for, if the first decoded picture is no longer required for inter-layer prediction reference, inter prediction reference and future output, removing the first decoded picture from the decoded picture buffer.

33. The electronic device of claim 32, wherein the memory unit further comprises computer code for carrying information related to an indication of possible inter-layer prediction reference of a subsequent picture in decoding order signaled in the bitstream.

34. The electronic device of claim 33, wherein the indication of possible inter-layer prediction reference is signaled in the slice header.

35. The electronic device of claim 33, wherein the indication of possible inter-layer prediction reference is signaled in the Network Abstraction Layer (NAL) unit header.

36. The electronic device of claim 33, wherein the determining of whether the first decoded picture is required for inter-layer prediction reference includes selectively marking the first decoded picture as “unused for inter-layer reference.”

37. The electronic device of claim 36, wherein the first decoded picture is marked as “unused for inter-layer reference” if the first picture belongs to the same access unit as the second picture.

38. The electronic device of claim 37, wherein the determining of whether the first decoded picture is marked as “unused for inter-layer reference” according to a signaling in the bitstream.

39. The electronic device of claim 36, wherein the first decoded picture is marked as “unused for inter-layer reference” if the first picture has the indication of possible inter layer prediction reference being positive and is marked as “used for inter-layer reference”.

40. The electronic device of claim 39, wherein the determining of whether the first decoded picture is marked as “unused for inter-layer reference” according to a signaling in the bitstream.

41. The electronic device of claim 36, wherein the first decoded picture is marked as “unused for inter-layer reference” if the first picture has a smaller value of dependency_id than the second picture or identical value of dependency_id but a smaller value of quality_level than the second picture.

42. The electronic device of claim 41, wherein the determining of whether the first decoded picture is marked as “unused for inter-layer reference” according to a signaling in the bitstream.

43. The electronic device of claim 36, wherein the first decoded picture is determined to be no longer required for inter-layer prediction reference if the first picture is marked as “unused for reference” or a non-reference picture; if the first picture is marked as “unused for inter-layer reference” or has the indication of possible inter layer prediction reference being negative; and if the first picture is either marked as “non-existing” is not in the desired scalable layer or has a decoded picture buffer output time less than or equal to a coded picture buffer removal time of the second picture.

44. The electronic device of claim 43, wherein, if the first decoded picture is a reference frame, the first decoded picture is considered to be marked as “unused for reference” only when both of the first decoded picture's fields have been marked as “unused for reference.”

45. The electronic device of claim 32, wherein the first decoded picture is not needed for future output if the first decoded picture is not in the desired scalable layer for playback.

46. The electronic device of claim 32, wherein the bitstream comprises a first sub-bitstream and a second sub-bitstream, the first sub-bitstream comprising coded pictures belonging to the first layer and the second sub bit stream comprising pictures of said second layer.

47. The electronic device of claim 32, wherein the electronic device comprises a decoder configured to read syntax elements for the indication of possible reference and memory management control operations from the bit stream.

48. An encoder for forming an encoded stream of pictures, the pictures being defined as reference pictures or non-reference pictures, and information relating to decoding order and output order of a picture is defined for pictures in the stream, wherein the encoder places syntax elements for the indication of possible reference and memory management control operation into the stream, the syntax elements being generated by the electronic device of claim 32.

49. A bit stream comprising
a syntax element providing an indication to selectively removing a first decoded picture of a first layer from the decoded picture buffer in light of a second decoded picture of a second layer.

50. A computer device implementing an encoder that generates a bitstream according to claim 48.

51. A bit stream comprising
a syntax element providing an indication to selectively remove a first decoded picture of a first layer from the decoded picture buffer in light of a second decoded picture of a second layer, wherein the syntax element is set according to the method of claim 1.

52. A method of managing a decoded picture buffer for scalable video coding, comprising:
receiving a first decoded picture belonging to a first layer in a bitstream into the decoded picture buffer;
receiving a second decoded picture belonging to a second layer;
determining whether the first decoded picture is required for inter-layer prediction reference, inter prediction reference and future output, in light of the receipt of the second decoded picture; and
if the first decoded picture is no longer required for inter-layer prediction reference, inter prediction reference and future output, removing the first decoded picture from the decoded picture buffer.
